(19) United States
(12) Patent Application Publication
(10) Pub. No.: US 2013/0067168 A1
(43) Pub. Date: Mar. 14, 2013

(54) CACHING FOR A FILE SYSTEM

(71) Applicants: Sarosh Cyrus Havewala, Kirkland, WA (US); Apurva Ashwin Doshi, Seattle, WA (US); Neal R. Christiansen, Bellevue, WA (US); Atul Pankaj Talesara, Redmond, WA (US)

(72) Inventors: Sarosh Cyrus Havewala, Kirkland, WA (US); Apurva Ashwin Doshi, Seattle, WA (US); Neal R. Christiansen, Bellevue, WA (US); Atul Pankaj Talesara, Redmond, WA (US)

(73) Assignee: Microsoft Corporation, Redmond, WA (US)

(21) Appl. No.: 13/228,453

(22) Filed: Sep. 9, 2011

(51) Int. Cl. G06F 12/08

(52) U.S. Cl. 711/118; 711/E12.017

(57) ABSTRACT

Aspects of the subject matter described herein relate to caching data for a file system. In aspects, in response to requests from applications and storage and cache conditions, cache components may adjust throughput of writes from cache to the storage, adjust priority of I/O requests in a disk queue, adjust cache available for dirty data, and/or throttle writes from the applications.

### BACKGROUND

A file system may include components that are responsible for persisting data to non-volatile storage (e.g. a hard disk drive). Input and output (I/O) operations to read data from and write data to non-volatile storage may be slow due to the latency for access and the I/O bandwidth that the disk can support. In order to speed up access to data from a storage device, file systems may maintain a cache in high speed memory (e.g., RAM) to store a copy of recently accessed data as well as data that the file system predicts will be accessed based on previous data access patterns.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to caching data for a file system. In aspects, in response to requests from applications and storage and cache conditions, cache components may adjust throughput of writes from cache to the storage, adjust priority of I/O requests in a disk queue, adjust cache available for dirty data, and/or throttle writes from the applications.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an environment that includes a cache and storage in accordance with aspects of the subject matter described herein;

FIG. 3 is a block diagram that generally represents another exemplary environment in which a file system uses a cache in accordance with aspects of the subject matter described herein;

FIG. 4 is a block diagram that illustrates a caching system in accordance with aspects of the subject matter described herein;

FIG. 5 is a block diagram that generally represents exemplary actions that may occur to increase throughput to storage in accordance with aspects of the subject matter described herein; and

FIG. 6 is a block diagram that generally represents exemplary actions that may occur to decrease throughput and/or increase responsiveness to read requests in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

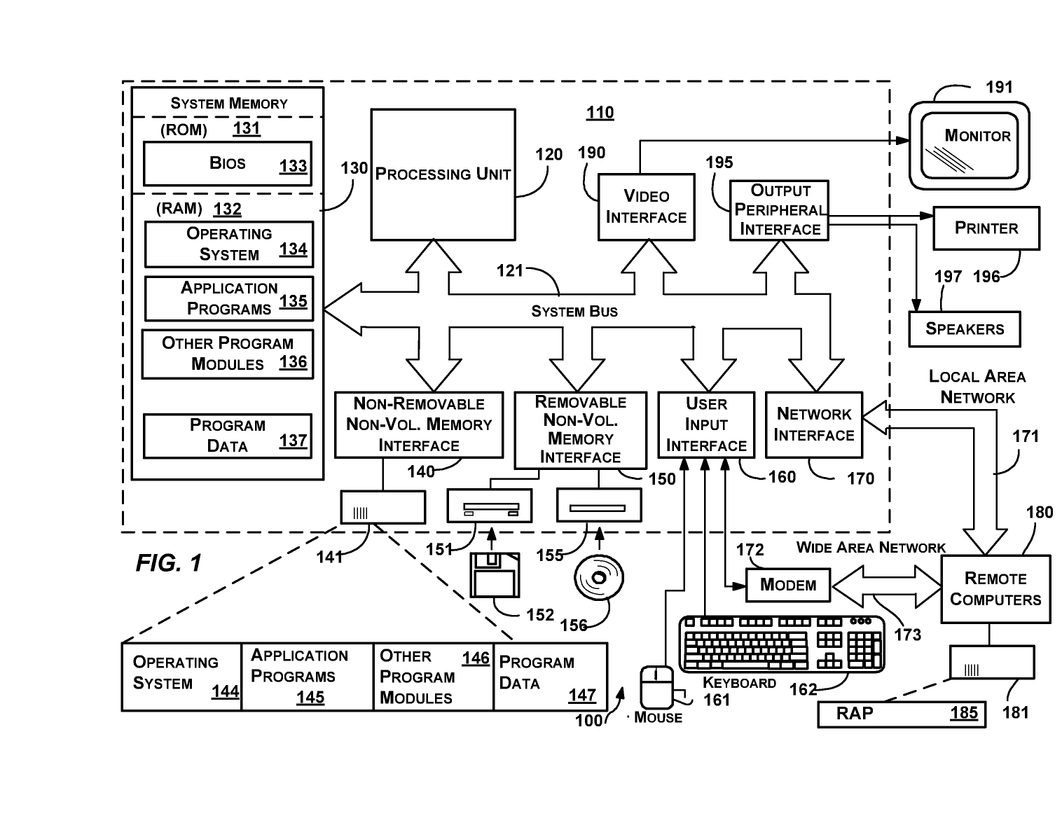

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, 6819 flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Caching

As mentioned previously, a file system may use a cache to speed access to data of storage. Access as used herein may include reading data, writing data, deleting data, updating data, a combination including two or more of the above, and the like.

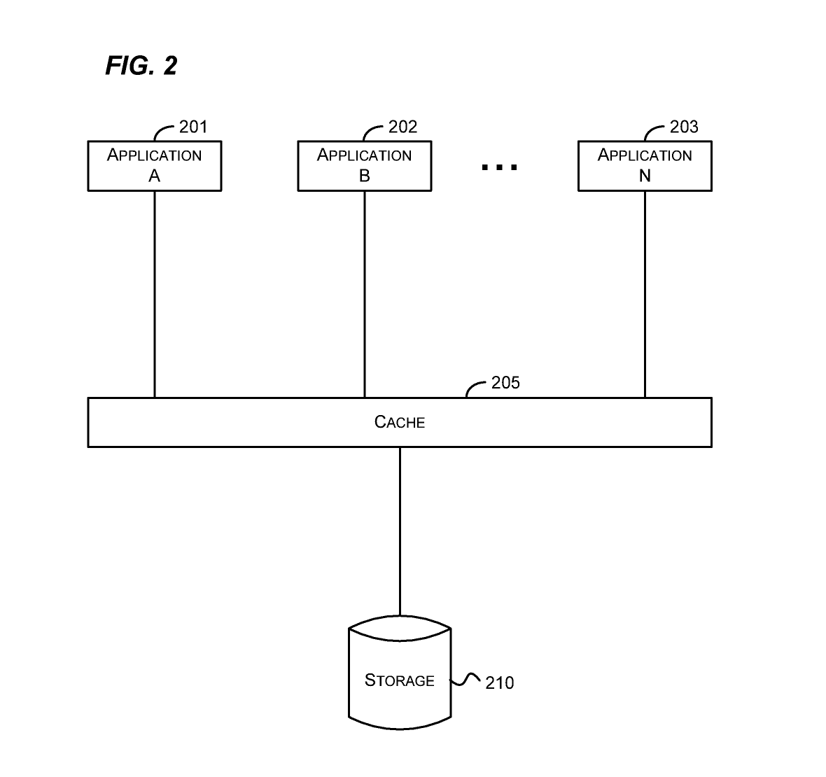

FIGS. 2-4 are block diagrams that represent components configured in accordance with the subject matter described herein. The components illustrated in FIGS. 2-4 are exemplary and are not meant to be all-inclusive of components that may be needed or included. In other embodiments, the components described in conjunction with FIG. 2-4 may be included in other components (shown or not shown) or placed in subcomponents without departing from the spirit or scope of aspects of the subject matter described herein. In some embodiments, the components and/or functions described in conjunction with FIG. 2-4 may be distributed across multiple devices.

The components illustrated in FIGS. 2-4 may be implemented using one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured to implement the components of FIGS. 2-4 comprises the computer 110 of FIG. 1.

FIG. 2 is a block diagram that generally represents an environment that includes a cache and storage in accordance with aspects of the subject matter described herein. As illustrated in FIG. 2, the environment may include applications 201-203, cache 205, and storage 210.

The applications 201-203 may include one or more processes that are capable of communicating with the cache 205. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. An application may execute in user mode, kernel mode, some other mode, a combination of the above, or the like.

The cache 205 includes a storage media capable of storing data. The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium.

Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

The cache 205 may be implemented on a single device (e.g., a computer) or may be distributed across multiple devices. The cache 205 may include volatile memory (e.g., RAM), and non-volatile memory (e.g., a hard disk or other non-volatile memory), a combination of the above, and the like.

The storage 210 may also include any storage media capable of storing data. In one embodiment, the storage 210 may include only non-volatile memory. In another embodiment, the storage may include both volatile and non-volatile memory. In yet another embodiment, the storage may include only volatile memory.

In a write operation, an application may send a command to write data to the storage 210. The data may be stored in the cache 205 for later writing to the storage 210. At some subsequent time, perhaps as soon as immediately after the data is stored in the cache 205, the data from the cache may be written to the storage.

In a read operation, an application may send a command to read data from the storage 210. If the data is already in the cache 205, the data may be supplied to the application from the cache 205 without going to the storage. If the data is not already in the cache 205, the data may be retrieved from the storage 210, stored in the cache 205, and sent to the application.

In some implementations, an application may be able to bypass the cache in accessing data from the storage 210.

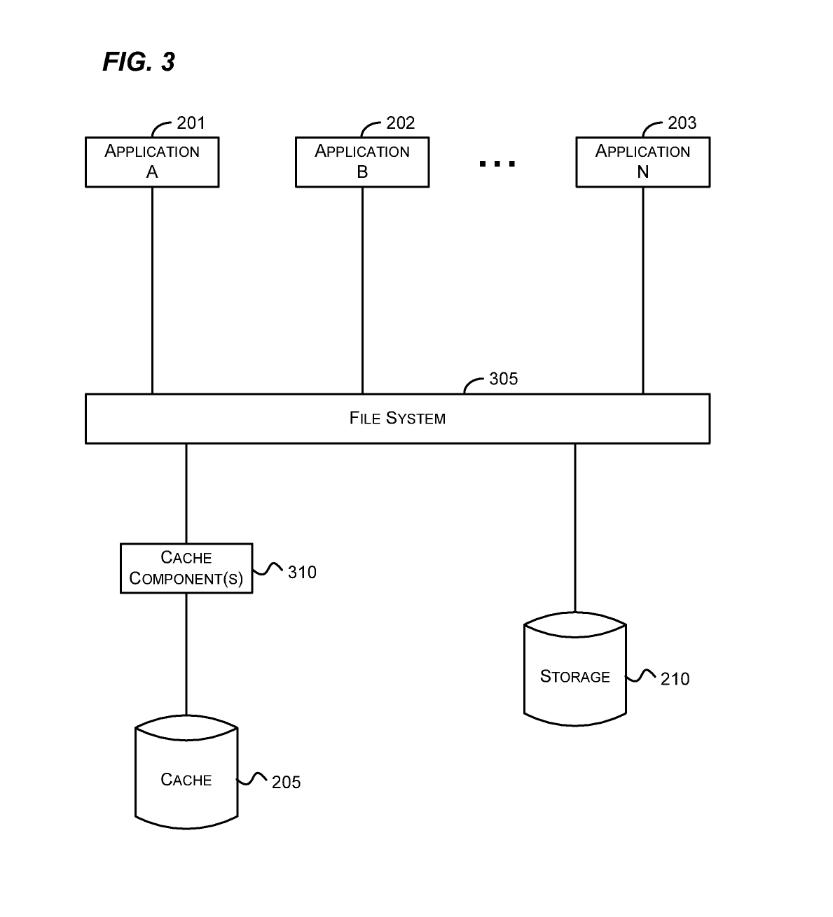

FIG. 3 is a block diagram that generally represents another exemplary environment in which a file system uses a cache in accordance with aspects of the subject matter described herein. As mentioned previously, a file system may include components that are responsible for persisting data to non-volatile storage.

As used herein, the term component is to be read to include hardware such as all or a portion of a device, a collection of one or more software modules or portions thereof, some combination of one or more software modules or portions thereof and one or more devices or portions thereof, and the like.

A component may include or be represented by code. Code includes instructions that indicate actions a computer is to take. Code may also include information other than actions the computer is to take such as data, resources, variables, definitions, relationships, associations, and the like.

The file system 305 may receive a read request from an application (e.g., one the applications 201-203) and may request the data from the cache component(s) 310. The cache component(s) 310 may determine whether the data requested by the file system resides in the cache 205. If the data resides in the cache 205, the cache component(s) 310 may obtain the data from the cache 205 and provide it to the file system 305 to provide to the requesting application. If the data does not reside in the cache, the cache component(s) 310 may retrieve the data from the storage 210, store the retrieved data in the cache 205, and provide a copy of the data to the file system 305 to provide to the requesting application.

Furthermore, the file system 305 may receive a write request from an application (e.g., one of the applications 201-203). In response, the file system 305 (or the cache component(s) 310 in some implementations) may determine whether the data is to be cached. For example, if the write request indicates that the data may be cached, the file system 305 may determine that the data is to be cached. If, on the other hand, the write request indicates that the data is to be written directly to non-volatile storage, the file system 305 may write the data directly to the storage 210. In some embodiments, the file system 305 may ignore directions from the application as to whether the data may be cached or not.

If the data is to be cached, the file system 305 may provide the data to the cache component(s) 310. The cache component(s) 310 may then store a copy of the data on the cache 205. Afterwards, the cache component(s) 310 may read the data from the cache 205 and store the data on the storage 210. In some implementations, the cache component(s) 310 may be able to store a copy of the data on the cache 205 in parallel with storing the data on the storage 210.

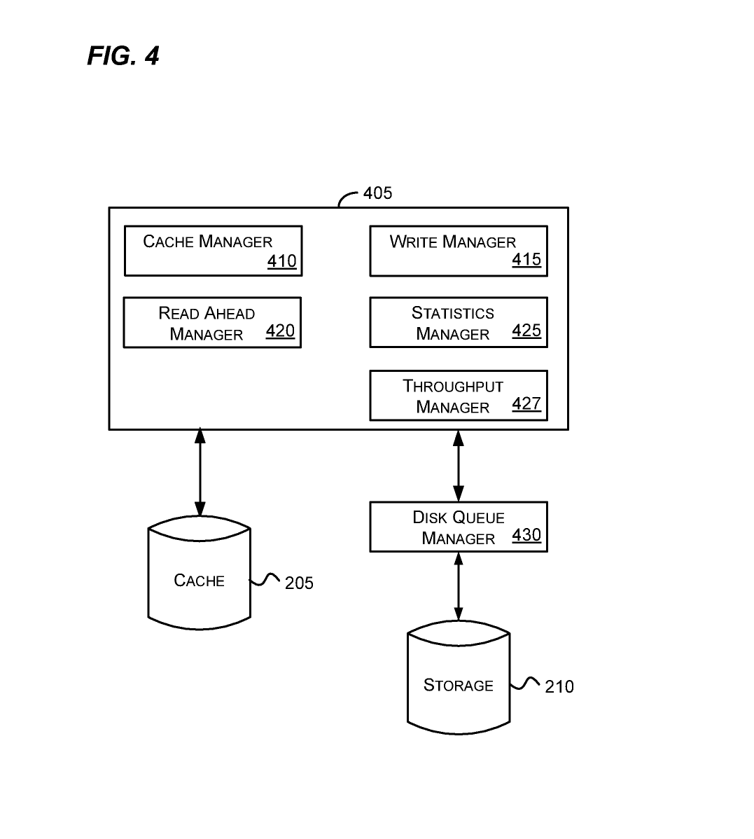

The cache component(s) 310 may include one or more components (described in more detail in conjunction with FIG. 4) that assist in caching data. For example, the cache component(s) 310 may employ a read ahead manager that obtains data from the file system that is predicted to be used by an application. The cache component(s) 310 may also employ a write manager that may write dirty pages from the cache 205 to the storage 210.

The cache component(s) 310 may utilize the file system 305 to access the storage 210. For example, if the cache component(s) 310 determines that data is to be stored on the storage 210, the cache component(s) 310 may use the file system 305 to write the data to the storage 210. As another example, if the cache component(s) 310 determines that it needs to obtain data from the storage 210 to populate the cache 205, the cache component(s) 310 may use the file system 305 to obtain the data from the storage 210. In one embodiment, the cache component(s) 310 may bypass the file system 305 and interact directly with the storage 210 to access data on the storage 210.

In one embodiment, the cache component(s) 310 may designate part of the cache 205 as cache that is available for caching read data and the rest of the cache 205 as cache that is available for caching dirty data. Dirty data is data that was retrieved from the storage 210 and stored in the cache 310, but that has been changed subsequently in the cache. The amount of cache designated for reading and the amount of cache designated for writing may be changed by the cache component(s) 310 during operation. In addition, the amount of memory available for the cache 205 may change dynamically (e.g., in response to memory needs).

FIG. 4 is a block diagram that illustrates a caching system in accordance with aspects of the subject matter described herein. The cache components 405 may include a cache manager 410, a write manager 415, a read ahead manager 420, a statistics manager 425, a throughput manager 427, and may include other components (not shown).

The statistics manager 425 may determine statistics regarding throughput to the storage 210. To determine throughput statistics, the statistics manager 425 may periodically collect data including:

1. The current number of dirty pages;

2. The number of dirty pages during the last scan.

The last scan is the most recent previous time at which the statistics manager 425 collected data. In other words, the last scan is the last time (previous to the current time) that the statistics manager 425 collected data;

3. The number of pages scheduled to write during the last scan. The last time statistics were determined, the cache manager 410 may have asked the write manager 415 to write a certain number of dirty pages to the storage 210. This number is known as the number of pages scheduled to write during the last scan; and

4. The number of pages actually written to storage since the last scan. During the last period, the write manager 415 may be able to write all or less than all the pages that were scheduled to be written to storage.

The period at which the statistics manager 425 collects data may be configurable, fixed, or dynamic. In one implementation the period may be one second and may vary depending on caching needs and storage conditions.

Using the data above, the statistics manager 425 may determine various values including the foreground rate and the effective write rate. The foreground rate may be determined using the following formula:

foreground rate=current number of dirty pages+number of pages scheduled to write during the last scan−number of dirty pages during the last scan.

The effective write rate may be determined using the following formula:

write rate=number of pages scheduled to write during the last scan−number of pages actually written to storage since the last scan

The foreground rate indicates how many pages have been dirtied since the last scan. In one implementation, the foreground rate is a global rate for all applications that are utilizing the cache. If the foreground rate is greater than the write rate, more pages have been put into the cache than have been written to storage. If the foreground rate is less than or equal to the write rate, the write manager 415 is keeping up with or exceeding the rate at which pages are being dirtied.

If the foreground rate is greater than the write rate, there are at least three possible causes:

1. The write manager 415 is not writing pages to disk as fast as it potentially can;

2. The write manager 415 is writing pages to disk as fast as is can, but the applications are creating dirty pages faster than the write manager 415 can write pages to disk;

3. The amount of cache devoted to read only pages and the amount of cache devoted to dirty pages is causing excessive thrashing which is reducing performance of the cache.

With the foreground rate and the other data indicated above, the cache manager 410 may estimate the number of dirty pages that there may be at the next scan. For example, the cache manager 410 may estimate this number using the following exemplary formula: Estimate of number of dirty pages at the next scan=current number of dirty pages+foreground rate−number of pages scheduled to write to storage before the next scan.

If this estimate is greater than or equal to a threshold of cached pages, the cache manager 410 may take additional actions to determine what to do. In one implementation, the threshold is 75%, although other thresholds may also be used without departing from the spirit or scope of aspects of the subject matter described herein.

If the foreground rate is greater than the write rate, the cache manager 410 may take additional actions to write dirty pages of the cache 205 to the storage 210 faster by flushing pages to disk faster or to reduce the rate at which pages in the cache 205 are being dirtied by throttling the writes of applications using the cache 205. The cache manager 410 may also adjust the amount of the cache that is devoted to read only pages and the amount of the cache that is devoted to dirty pages.

The cache manager 410 may instruct the throughput manager 427 to increase the write rate. In response, the throughput manager 427 may attempt to increase disk throughput for writing dirtied pages to storage.

In one implementation, a throughput manager 427 may attempt to adjust the number of threads that are placing I/O requests with the disk queue manager 430. In another implementation, the throughput manager 427 may adjust the number of I/Os using an asynchronous I/O model. Both of these implementations will be described in more detail below.

In the implementation in which the throughput manager 427 attempts to adjust the number of threads, the throughput manager 427 may perform the following actions to increase throughput:

1. Wait n ticks. A tick is a period of time. A tick may correspond to one second or another period of time. A tick may be fixed or variable and hard-coded or configurable.

2. Calculate dirty pages written to storage. This may be performed by maintaining a counter that tracks the number of dirty pages written to storage, subtracting a count that represents the current number of dirty pages from the previous number of dirty pages, or the like. This information may be obtainable from the statistics gathered above.

3. Update an average in a data structure that associates the number of threads devoted to writing dirty pages to storage with the average number of pages that were written to storage by the number of threads. For example, the data structure may be implemented as a table that has as one column thread count and as another column the average number of pages written.

4. Repeat steps 1-3 a number of times so that the average uses more data points.

5. Compare the throughput of the current number of threads (x) with the throughput of x−1 threads.

6. If the throughput of x−1 threads is greater than or equal to the throughput of x threads, reducing the number of threads used to write dirty pages to storage.

7. If the throughput of x threads is greater than the throughput of x−1 threads, adjusting the number of threads to x+1 threads.

The adjusting of throughput may be reversed if the cache manager 410 has indicated that less throughput is desired. In addition, the actions above may be repeated each time the cache manager 410 indicates that the throughput needs to be adjusted.

In this threading model, a thread may place a request to write data with a disk queue manager 430 and may wait until the data has been written before placing another request to write data into the disk queue 430.

In one embodiment, a flag may be set as to whether the number of threads may be increased. The flag may be set if the write rate is positive and dirty pages are over a threshold (e.g. 50%, 75%, or some other threshold). A positive write rate indicates that the write manager 415 is not keeping up with the scheduled pages to write. If the flag is set, the number of threads may be increased. If the flag is not set, the number of threads may not be increased even if this would result in increased throughput. This may be done, for example, to reduce the occurrence of spikes in writing data to the storage when this same data could be written slower while still meeting the goal of writing all the pages that have been scheduled to write.

In one embodiment, steps 6 and 7 may be replaced with:

6. If the throughput of x−1 threads is greater than or equal to the throughput of x threads+a threshold, reducing the number of threads used to write dirty pages to storage.

7. If the throughput x threads is greater than the throughput of x−1 threads+a threshold, adjusting the number of threads to x+1 threads.

This embodiment favors keeping the number of threads the same unless the throughput changes enough to justify a change in the number of threads.

In the implementation in which the throughput manager 427 uses an asynchronous I/O model, the throughput manager 427 may track the number of I/Os and the amount of data associated with the I/Os and may combine these values to determine a throughput value that represents a rate at which dirty pages are being written to the storage 210. The throughput manager 427 may then adjust the number of I/Os upward or downward to attempt to increase disk throughput. I/Os may be adjusted, for example, by increasing or decreasing the number of threads issuing asynchronous I/Os, having one or more threads issue more or less asynchronous I/Os, a combination of the above, or the like.

The throughput manager 427 may be able to asynchronously put I/O requests into the disk queue 430. This may allow the throughput manager 427 to put many I/O requests into the disk queue 430 in a relatively short period of time. This may cause an undesired spike in disk activity and reduced responsiveness to other disk requests.

Even though the throughput manager 427 may be dealing asynchronously with the disk queues, the throughput manager 427 may put I/O requests into the disk queue 430 such that the I/O requests are spread across a scan period. For example, if the throughput manager 427 is trying to put 100 I/Os onto the disk queue 430 in a 1 second period, the throughput manager 427 may put 1 I/Os on the disk queue 430 each 10 milliseconds, may put 10 I/Os on the disk queue 430 each 100 milliseconds, or may otherwise spread I/Os over the period.

In one embodiment in which the throughput manager 427 uses an asynchronous I/O model, the throughput manager 427 may perform the following actions:

1. Wait n ticks.

2. Calculate dirty pages written to storage.

3. Update an average in a data structure that associates the number of concurrent outstanding I/Os for writing dirty pages to storage with the average number of pages that were written to storage by the number of concurrent I/Os. For example, the data structure may be implemented as a table that has as one column concurrent outstanding I/Os and as another column the average number of pages written.

4. Repeat steps 1-3 a number of times so that the average uses more data points.

5. Compare the throughput of the current number of concurrent outstanding I/Os (x) with the throughput of x−1 concurrent outstanding I/Os.

6. If the throughput of x−1 concurrent outstanding I/Os is greater than or equal to the throughput of x concurrent outstanding I/Os, reducing the number of concurrent outstanding I/Os that may be issued by the throughput manager used to write dirty pages to storage.

7. If the throughput of x concurrent outstanding I/Os is greater than the throughput of x−1 concurrent outstanding I/Os, increasing the number of concurrent outstanding I/Os that the throughput manager may issue to x+1 concurrent outstanding I/Os.

In some cases, it may be desirable to decrease the priority of writing dirty pages to the storage 210. For example, when the number of dirty pages is below a low threshold, there may be little or no danger of the write manager 415 being able to keep up with writing dirty pages to the storage 210. For example, this low threshold may be set as a percentage of total cache pages and be below the previous threshold mentioned above at which the throughput manager 427 is invoked to more aggressively write pages to storage. This condition of being below the low threshold of dirty pages is sometimes referred to herein as low cache pressure.

When low cache pressure exists, the write manager 415 may be instructed to issue lower priority write requests to the disk queue 430. For example, if the write manager 415 was issuing write requests with a normal priority, the write manager 415 may begin issuing write requests with a low priority.

The disk queue 430 may be implemented such that it services higher priority I/O requests before it services lower priority I/O requests. Thus, if the disk queue 430 has a queue of low priority write requests and receives a normal priority read request, the disk queue 430 may finish writing a current write request and then service the normal priority read request before servicing the rest of the low priority write requests.

The behavior above may make the system more responsive to read requests which may translate into more responsiveness to a user using the system.

If while the write manager 415 is sending dirty pages to the storage 210 with low priority, an application indicates that outstanding write requests for a file(s) are to be expeditiously written to the disk, the write manager 415 may elevate the priority of write requests for the file(s) by instructing the queue manager 430 and may issue subsequent write requests for the file with the elevated priority. For example, a user may be closing a word processor and the word processing application may indicate that outstanding write requests are to be flushed to disk. In response, the write manager 415 may elevate the priority of write requests for the file(s) indicated both in the disk queue and for subsequent write requests associated with the file(s).

The write manager 415 may be instructed to elevate the priority for I/Os at a different granularity than files. For example, the write manager 415 may be instructed to elevate the priority I/Os that affect a volume, disk, cluster, block, sector, other disk extent, other set of data, or the like.

It was indicated earlier that the foreground rate may be greater than the write rate because the applications are creating dirty pages faster than the write manager 415 can write pages to disk. If this is the case and the threshold has been exceeded, the applications may be throttled in their writing. For example, if the throughput manager 427 determines a throughput rate to the storage 210, the write rate of the applications may be throttled by a percentage of the throughput rate.

For example, if the throughput manager 427 determines that the throughput rate of the storage 210 is 20 pages per interval and the dirty page threshold is 1000, when the total dirty pages reach this threshold, the throughput manager 427 may reduce the dirty page threshold by 10 pages (e.g., 50% of 20) bringing the dirty page threshold down from 1000 to 990. If the total dirty pages reach this new dirty page threshold, it may be reduced again. This has the effect of incrementally throttling the applications instead of suddenly cutting off the ability to write, waiting for outstanding dirty pages to be written, then allowing the applications to instantly begin writing again, and so forth. The former method of throttling may provide a smoother and less erratic user experience than the latter.

In one implementation, this throttling may be accomplished by the cache manager informing the file system to hold a write request until the cache manager indicates that the write request may proceed. In another implementation, the cache manager may wait to respond to a write request thus throttling the write request without explicitly informing the file system. The implementations above are exemplary only and other throttling mechanisms may be used without departing from the spirit or scope of aspects of the subject matter described herein.

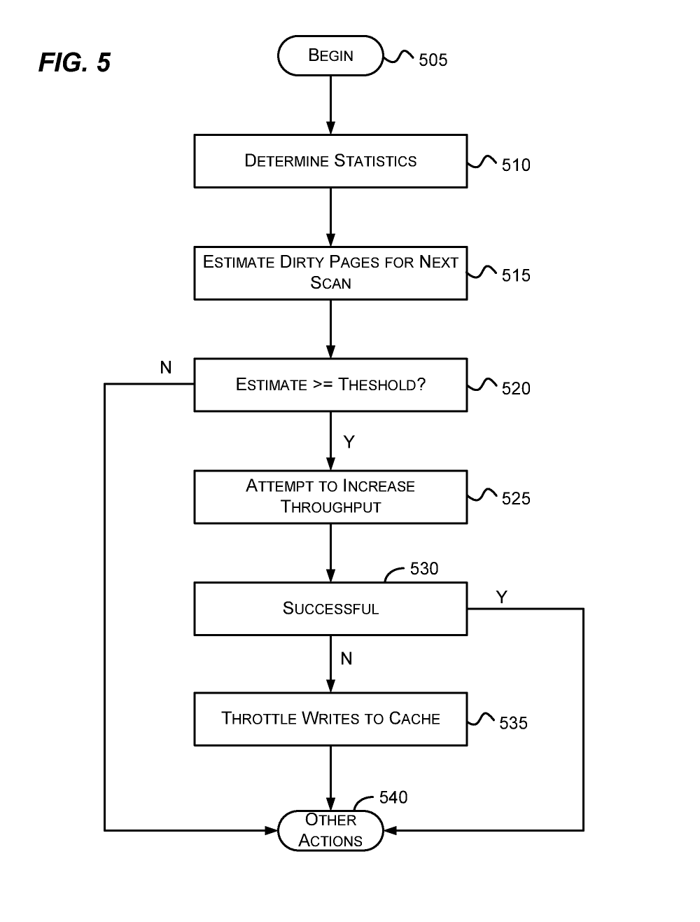

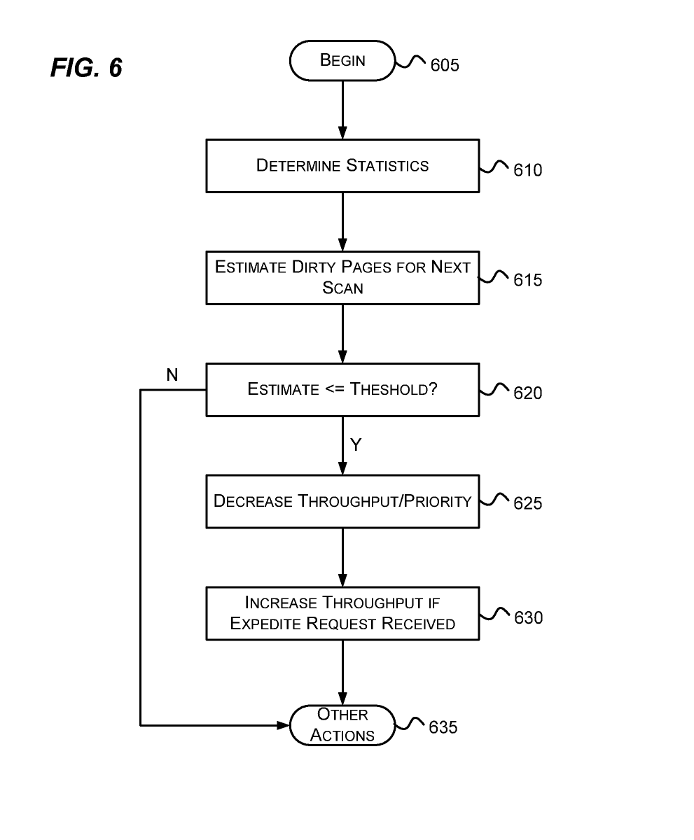

FIGS. 5-6 are flow diagrams that generally represent exemplary actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 5 is a block diagram that generally represents exemplary actions that may occur to increase throughput to storage in accordance with aspects of the subject matter described herein. Turning to FIG. 5, at block 505, the actions begin.

At block 510, statistics are determined for throughput. For example, referring to FIG. 4, the statistics manager 425 may record throughput values indicated previously and may calculate statistics therefrom. For example, the statistics manager 425 may determine a foreground rate that indicates a number of pages that have been dirtied since the previous time. This foreground rate may be based on the current number of dirty pages obtained at a current time (e.g., the current scan), the previous number of dirty pages obtained at a previous time (e.g., the last scan), and the number of dirty pages scheduled to be written to storage during an interval between the previous time and the current time.

As another example, the statistics manager 425 may determine a write rate that indicates a number of pages that have been written to the storage. The write rate may be based on the scheduled number of dirty pages scheduled to be written to storage during an interval between the previous time and the current time and the actual number of dirty pages actually written to storage during the interval as previously described.

At block 515, an estimate for the dirty pages for the next scan may be determined. For example, referring to FIG. 4, the statistics manager 425 may determine, based on the statistics just determined an estimate of dirty pages for the next scan. If the estimate exceeds or reaches a threshold (e.g., 75% or another threshold of dirty pages), the statistics manager 425 may generate an indication that the threshold of dirty pages in a cache has already or is estimated to be reached or exceeded at the current throughput to storage.

At block 520, a determination is made as to whether this estimate is greater than or equal to a threshold of dirty pages in the cache. If so, the actions continue at block 520; otherwise, the actions continue at block 540.

At block 525, an attempt to increase throughput to the storage is performed. For example, referring to FIG. 4, the throughput manager 427 may attempt to adjust threads, I/O requests, priorities, and/or size allocated for dirty pages as described previously. For example, the throughput manager 427 may measure throughput at two or more times during an interval, calculate an average throughput based on the measured throughput, and adjust the number of write requests sent to a disk queue based on the above.

At block 530, if the attempt is successful, the actions continue at block 540; otherwise, the actions continue at block 535. In one embodiment, an attempt to increase throughput may be deemed unsuccessful if a second threshold of dirty pages is reached or exceeded. In another embodiment, an attempt to increase throughput may be deemed unsuccessful if the new write rate does not exceed the new foreground rate at the next scan.

At block 535, as the attempt to increase throughput to storage was unsuccessful, writes to the cache are throttled. For example, referring to FIG. 4, the cache manager 410 may incrementally reduce the write rate at which applications are allowed to have writes serviced by the cache 205 as indicated previously.

At block 540, other actions, if any, may be performed. Other actions may include, for example, adjusting priority associated with a set of writes (e.g., for a file, volume, disk extent, block, sector, or other data as mentioned previously). This priority may affect when the writes are serviced by a disk queue manager.

FIG. 6 is a block diagram that generally represents exemplary actions that may occur to decrease throughput and/or increase responsiveness to read requests in accordance with aspects of the subject matter described herein. Turning to FIG. 6, at block 605, the actions begin.

At block 610, statistics are determined for throughput. For example, referring to FIG. 4, the statistics manager 425 may determine statistics similarly to how statistics are determined at block 510 of FIG. 5.

At block 615, an estimate for the dirty pages for the next scan may be determined. For example, referring to FIG. 4, the statistics manager 425 may estimate dirty pages for the next scan similarly to how dirty pages for the next scan are determined at block 515 of FIG. 5.

At block 620, if the estimate is less than or equal to a low threshold, the actions continue at block 625; otherwise, the actions continue at block 635.

At block 625, in response to determining that a first threshold of dirty pages in the cache has already or is estimated to be reached or crossed at the current throughput to storage, the throughput/priority to storage may be reduced. For example, referring to FIG. 4, the throughput manager 427 may reduce the number of threads available to send I/O requests to the disk queue manager 430, reducing a number of write requests to a disk queue for dirty pages of the cache, change the size allocated for dirty pages, and/or may instruct the write manager 415 to decrease priority of existing writes and subsequent writes to the storage.

At block 630, if an expedite writes request is received, the priority/throughput to storage may be increased. For example, referring to FIG. 4, if the cache manager 410 receives a request that an application is shutting down and wants to flush outstanding writes to disk, the cache manager 410 may instruct the write manager 415 to increase the priority of outstanding writes as well as subsequent writes received from the application.

At block 635, other actions, if any, may be performed.

As can be seen from the foregoing detailed description, aspects have been described related to caching data for a file system. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving an indication that a first threshold of dirty pages in a cache has already or is estimated to be reached or exceeded at a current throughput to storage;
attempting to increase the throughput to storage; and
if the attempting to increase throughput to storage is unsuccessful, throttling writes to the cache.

2. The method of claim 1, further comprising obtaining statistics regarding the pages in the cache, the statistics indicating:
a current number of dirty pages obtained at a current time;
a previous number of dirty pages obtained at a previous time that is previous to the current time;
a scheduled number of dirty pages scheduled to be written to storage during an interval between the previous time and the current time; and
an actual number of dirty pages actually written to storage during the interval.

3. The method of claim 2, further comprising determining a foreground rate that indicates a number of pages that have been dirtied since the previous time, the foreground rate being based on the current number, the previous number, and the scheduled number.

4. The method of claim 3, further comprising determining a write rate that indicates a number of pages that have been written to the storage, the write rated being based on the scheduled number and the actual number.

5. The method of claim 4, further comprising estimating based on the foreground rate, the write rate, and the current number of dirty pages, that the first threshold will be reached or exceeded at a future time that is subsequent to the current time.

6. The method of claim 5, further comprising generating the indication in response to estimating that the threshold will be reached or exceeded.

7. The method of claim 1, wherein attempting to increase the throughput to the storage comprises determining a measured throughput at two or more times during an interval, calculating an average throughput based on the measured throughput, and adjusting a number of threads assigned to put write requests into a disk queue based on the average throughput and a previously computed average throughput of a different number of threads.

8. The method of claim 1, wherein attempting to increase the throughput to the storage comprises determining a measured throughput at two or more times during an interval, calculating an average throughput based on the measured throughput, and adjusting a number of write requests sent to a disk queue.

9. The method of claim 1, wherein throttling writes to the cache comprises incrementally reducing the write rate at which applications are allowed to have writes serviced.

10. The method of claim 1, wherein the attempting to increase the throughput to storage is unsuccessful if a second threshold of dirty pages is reached or exceeded.

11. The method of claim 1, wherein attempting to increase the throughput to storage comprises attempting to increase throughput for a set of writes by increasing a priority associated with the set of writes, the priority affecting when the writes are serviced by a disk queue manager.

12. The method of claim 1, wherein attempting to increase the throughput to storage comprises reducing a number of pages allowed for dirty pages of the cache.

13. A computer storage medium having computer-executable instructions, which when executed perform actions, comprising:
determining statistics regarding a first throughput of dirty pages written from a cache to storage;
based on the statistics, determining that a first threshold of dirty pages in the cache has already or is estimated to be reached or crossed at a current throughput to storage; and
in response to the determining that a first threshold of dirty pages in the cache has already or is estimated to be reached or crossed at the current throughput to storage, reducing the throughput to storage.

14. The computer storage medium of claim 13, wherein determining statistics regarding a first throughput comprises determining:
a current number of dirty pages obtained at a current time;
a previous number of dirty pages obtained at a previous time that is previous to the current time;
a scheduled number of dirty pages scheduled to be written to storage during an interval between the previous time and the current time; and
an actual number of dirty pages actually written to storage during the interval.

15. The computer storage medium of claim 13, wherein reducing the throughput to storage comprises reducing a number of threads assigned to put write requests into a disk queue.

16. The computer storage medium of claim 13, wherein reducing the throughput to storage comprises reducing a number of write requests to a disk queue for dirty pages of the cache.

17. The computer storage medium of claim 13, wherein reducing the throughput to storage comprises reducing a priority associated with a set of writes, the priority affecting when the writes are serviced by a disk queue manager.

18. The computer storage medium of claim 17, further comprising increasing the priority upon receipt of an indication that the writes are to be expedited to storage.

19. In a computing environment, a system, comprising:
a storage operable to store data of a file system;
a cache operable to store a subset of the data of the storage;
a set of one or more cache components operable to perform actions, comprising:
determining a current throughput of dirty pages written from the cache to the storage;
determining that a threshold has been reached or crossed, the threshold triggering the one or more cache components to attempt to adjust the throughput of dirty pages written from the cache to the storage;
attempting to adjust the throughput in response to the determining that the threshold has been reached or crossed.

20. The system of claim 19 wherein the set of one or more cache components are further operable to gather statistics, the statistics indicating:
a current number of dirty pages obtained at a current time;
a previous number of dirty pages obtained at a previous time that is previous to the current time;
a scheduled number of dirty pages scheduled to be written to storage during an interval between the previous time and the current time; and
an actual number of dirty pages actually written to storage during the interval,
the statistics usable by the one or more cache components to determine the current throughput of dirty pages written from the cache to the storage.
